(19) United States
(12) Patent Application Publication
(10) Pub. No.: US 2005/0156070 A1
(43) Pub. Date: Jul. 21, 2005

(54) Wear part intended for a crusher and a method of manufacturing the same

(76) Inventors: Per Artberger Olsson, Malmo (SE); Anders Nilsson, Malmo (SE); Pierre Landen, Eslov (SE)

Correspondence Address: BURNS DOANE SWECKER & MATHIS L L P, POST OFFICE BOX 1404, ALEXANDRIA, VA, 22313-1404, US

(21) Appl. No.: 10/515,233

(22) PCT Filed: May 22, 2003
(86) PCT No.: PCT/SE03/00829

(30) Foreign Application Priority Data
May 23, 2002 (SE) 0201540-2

(51) Int. Cl. B02C 2/00

(52) U.S. Cl. 241/207; 241/300

(57) ABSTRACT

A wear part (5) for detachable mounting on a supporting part in an impact-type multi-action crusher is at least partly manufactured by hot isostatic pressing. The wear part (5) has a body (19) for mounting of the wear part (5) on the supporting part and a crushing layer (20) which is attached to the body (19) and which is adapted to be brought, during operation of the crusher, into repeated contact with a raw material that is to be crushed. The body (19) is made of a substance which is easy to machine to narrow tolerances, and the crushing layer (20) is made of a material (27, 28) of high abrasive resistance. In a method of manufacturing the above wear part (5), the following steps are carried out: introducing at least one powder material (27, 28) into a capsule, degassing and sealing the capsule, subjecting the material (27, 28) in the capsule to hot isostatic pressing to form a crushing layer (20), and then after treatment of the wear part (5).

### FIELD OF THE INVENTION

The present invention relates to a wear part for detachable mounting on a supporting part in an impact-type multi-action crusher. The invention also relates to a method of manufacturing such a wear part.

### BACKGROUND OF THE ART

Impact-type multi-action crushers, such as gyratory crushers and jaw crushers, crush a raw material, such as a stone block, ore block, concrete or brick block or the like, by a wear part being repeatedly moved towards the raw material to crush it against a counterbody. The wear part is supported by a supporting part which transmits the necessary force from a motor, moment arm, shaft or the like to the wear part. The crushing operation causes wear on the wear part, which therefore now and then must be detached from the supporting part and replaced.

For maximum life, the wear part is made of a material which has maximum abrasive resistance. The wear part is usually cast from what is referred to as Hadfield steels. These steels, which are described, for instance, in U.S. Pat. No. 5,069,871 and EP 0 692 548, are austenitic manganese steels. A Hadfield steel has the property that the surface of the steel is hardened (deformation hardening) when the steel is acted upon by the raw material in the crusher, which results in good abrasive resistance.

For the supporting part to give sufficient support to the wear part, which is necessary to prevent the wear part from being deformed or cracking or from deforming the supporting part, the abutment surface of the wear part on the supporting surface of the supporting part must be machined to narrow tolerances. The problem is that the Hadfield steels also in such machining will be deformation-hardened, which makes machining difficult and time consuming.

### SUMMARY OF THE INVENTION

The object of the present invention is to provide a wear part for an impact-type multi-action crusher, said wear part having good abrasive resistance and being easy to machine to narrow tolerances.

This object is achieved by a wear part for detachable mounting on a supporting part in an impact-type multi-action crusher, said wear part being characterized in that the wear part is at least partly manufactured by hot isostatic pressing, and that the wear part has a body for mounting of the wear part on the supporting part and a crushing layer which is attached to the body and adapted to be brought, during operation of the crusher, into repeated contact with a raw material which is to be crushed, the body being made of a substance which is easy to machine to narrow tolerances, and the crushing layer being made of a material of high abrasive resistance. By the wear part being divided into a body and a crushing layer, each part can be given the properties that are the most important ones for the part in question. Thus, the crushing layer is optimized for good abrasive resistance and the body for good machinability. By hot isostatic pressing, parts with complicated geometric structures can be produced also of materials that could otherwise not be used.

According to a preferred embodiment, the crushing layer is made of at least one powder material which has been subjected to hot isostatic pressing, the substance of which the body is made also having good weldability. There are a plurality of powder materials which are suitable as crushing layer and which can be subjected to hot isostatic pressing to form such a layer. A body which has good weldability is advantageous since the wear part is often fixed by welding.

Preferably, the crushing layer comprises at least two powder materials, which, without first being completely mixed with each other, have been subjected to hot isostatic pressing and which, after said pressing and subsequent aftertreatment, have different abrasive resistances, the crushing layer having portions of different abrasive resistances. The use of at least two materials makes it possible to vary the abrasive resistance of the crushing layer to obtain specific properties, such as improved abrasive resistance in some portions and lower abrasive resistance in other portions. Since the two materials are not mixed with each other, or at least not completely mixed with each other, there will, after the hot isostatic pressing, be portions with different abrasive resistances. If a highly abrasive resistant material, which is expensive, is used, this can be located in the portions of the crushing layer where the highest abrasive resistance is required, while a less expensive material can be used in the remaining portions. The material which after pressing and after-treatment has the highest abrasive resistance is therefore conveniently arranged in the portions of the crushing layer where the greatest wear is to be expected. In this way, a more even wear is obtained over the surface of the wear part, which ensures a longer life of the wear part.

Preferably, the crushing layer and the body are joined by a bonding zone. The bonding zone, which may be formed, for instance, when a powder material in contact with a compact material is subjected to hot isostatic pressing, results in a safe connection between the body and crushing layer over the entire contact surface and renders it possible to do without a screw joint, weld joint and the like.

The body is suitably at least partly made of a substance selected from a group consisting of carbon steels and low alloy steels. These substances are easy to machine, have good weldability and are available at a low price. A body made of one of these substances can, for instance, be cast, machined or forged to the desired basic shape and then be finished to narrow tolerances. The body can also be made of a powder of one of the above substances, which is then subjected to hot isostatic pressing.

Preferably, a first portion of the crushing layer is made of at least one first powder material and, located downstream of said first portion in the direction of flow of the raw material, a second portion of the crushing layer is made of at least one second powder material, which, after subjecting the materials to hot isostatic pressing and subsequent aftertreatment, has higher abrasive resistance than the first material, whereby the second portion has higher abrasive resistance than the first portion. Wear is usually greatest in the portions located downstream in the direction of flow of the raw material since a larger number of objects are to be crushed in these portions. By locating the material having the highest abrasive resistance in these portions, it is thus possible to extend the life of the wear part. According to a still more preferred embodiment, the first material gradually merges into the second material in such a manner that the crushing layer obtains an abrasive resistance which increases gradually in the direction of flow of the raw material and which corresponds to the wear load in operation so that the profile of the wearing layer is kept essentially intact during the life of the wear part. This has the advantage that the crusher will have essentially the same and, thus, predictable capacity during the entire life of the wear part.

According to a preferred embodiment, the crushing layer has at least one protrusion protruding from the crushing layer and being made of at least one powder material which, after subjecting the powder materials to hot isostatic pressing and subsequent aftertreatment, has higher abrasive resistance than the powder material or materials of which the parts of the crushing layer which surround the protrusion are made. The protrusion will be exposed to particularly great wear load. At the same time the protrusion is, in the cases when it is being used, critical to the function of the wear part. By locating the most wear resistant material in the protrusion, the life of the wear part can thus be extended significantly.

According to another preferred embodiment, the crushing layer has at least one protrusion protruding from the crushing layer and being made by casting, sintering or forging and having higher abrasive resistance than the powder material or materials of which the parts of the crushing layer which surround the protrusion are made. Thus the protrusion can be made of materials, such as sintered tungsten carbide, which have excellent abrasion resistance but are better suited for other manufacturing methods than hot isostatic pressing. The protrusion can also be made of cast materials, such as Hadfield steels. Then it is possible to deformation-harden the protrusion in advance, before attaching it to the crushing layer. The parts of the crushing layer which surround and fix the protrusion are also in these cases made of at least one powder material which has been subjected to hot isostatic pressing.

The wear part can be an inner shell or an outer shell for use in a gyratory crusher. In gyratory crushers, the requirements for narrow tolerances in the abutment of the wear part on the supporting surface are strict, which makes the invention particularly suitable for this type of crushers.

According to a particularly preferred embodiment, the protrusion has the form of a rotationally symmetric step extending round the crushing layer. The step improves the crushing of the raw material and improves the grain shape of the crushed raw material. According to a preferred embodiment, the crushing layer comprises at least two powder materials, which, after subjecting the materials to hot isostatic pressing, have different hardnesses, the softer of the two materials being located in a first layer closest to the body and the harder of the two materials being located in a second layer on the outside of the first layer. As a result, a very hard, but brittle, material can be used in the outer layer of the crushing layer and be supported by a softer material placed under the outer layer.

The object of the present invention is also to provide a method of manufacturing a wear part for an impact-type multi-action crusher, said wear part having great abrasive resistance and being easy to machine to narrow tolerances.

According to the invention, this object is achieved by a method of manufacturing a wear part for detachable mounting on a supporting part in an impact-type multi-action crusher, said method being characterized in that the wear part is manufactured as a body for mounting of the wear part on the supporting part and a crushing layer which is attached to the body and adapted to be brought, during operation of the crusher, into repeated contact with a raw material which is to be crushed, the body being made of a substance which is easy to machine to narrow tolerances, and the crushing layer being made of a material of high abrasive resistance by at least one powder material being introduced into a capsule, the capsule being degassed and sealed and the material in the capsule being subjected to hot isostatic pressing, after which the wear part is subjected to aftertreatment. By the wear part being divided into a body and a crushing layer, each part can be given the properties that are the most important ones for the part in question. Thus, the crushing layer is optimized for good abrasive resistance and the body for good machinability. By hot isostatic pressing, parts with complicated geometric structures can be manufactured. The abrasive resistant materials that are normally of interest for use in the crushing layer are often very difficult to machine to complicated geometric structures.

According to a preferred method, at least two powder materials, which after hot isostatic pressing and subsequent aftertreatment have different abrasive resistances, are introduced into the capsule without being completely mixed with each other, in such a manner that the material of the highest abrasive resistance is arranged in the parts of the capsule which correspond to the portions of the crushing layer where the greatest wear is to be expected. If a highly abrasive resistant material, which is expensive, is used, this can be located in the portions of the crushing layer where the highest abrasive resistance is required, while a less expensive material can be used in the remaining portions. A further advantage is that the wear on the wear part will be more even than if the same material is used in the entire crushing layer. Unevenly worn crushing layers constitute a common source of functional troubles and shortened life of wear parts.

Preferably, the body of the wear part is used as a wall in the capsule to be joined with the crushing layer. This saves a wall in the capsule that is used. Moreover, the advantage is achieved that the body and crushing layer are joined by a bonding zone which will be very strong since it covers the entire surface where the body and the crushing layer are in contact with each other. Nor is a weld joint, bolt joint or the like required to hold the body and the crushing layer together.

According to a preferred method, at least one first powder material is introduced into a first part of the capsule which corresponds to a first portion of the crushing layer and at least one second powder material is introduced into a second part of the capsule which corresponds to a second portion of the crushing layer, which second portion is located downstream of the first portion in the direction of flow of the raw material, the second material in the second portion, after subjecting the materials to hot isostatic pressing and subsequent after-treatment, having higher abrasive resistance than the first material. Uneven wear is a great problem in many crushers, especially in gyratory crushers. Owing to the wear which usually is greatest in the portions positioned downstream in the direction of flow of the raw material, the crusher capacity of crushing a raw material is reduced and, after a certain period of operation of the wear part, the crusher cannot crush the raw material to the same small sizes, and therefore the wear part must be replaced. By a more abrasive resistant material being used in the portion of the crushing layer which is close to the end point of the flow of raw material, the life of the wear part can be increased significantly. According to a particularly preferred-method, the first material and the second material are introduced into the capsule in such a manner that the first material gradually merges into the second material, the crushing layer obtaining an abrasive resistance that increases gradually in the direction of flow of the raw material and corresponds to the wear load in operation, so that the profile of the crushing layer is kept essentially intact during the life of the wear part. As mentioned above, this has the advantage that the performance of the crusher will be constant and thus predictable for the entire life of the crusher.

According to a preferred method, the crushing layer is manufactured with at least one protrusion protruding from the crushing layer, at least one powder material being introduced into the capsule in the parts of the capsule which correspond to the protrusion and at least one other powder material being introduced into the parts of the capsule which correspond to the parts of the crushing layer which surround the protrusion, the material of the protrusion, after subjecting the materials to hot isostatic pressing and subsequent after-treatment, having higher abrasive resistance than the material of the parts of the crushing layer which surround the protrusion. As mentioned above, the life of the protrusion will thus be increased, which ensures the above advantages of longer life for the entire wear part.

According to another preferred method, the protrusion is manufactured in a first step by hot isostatic pressing, after which the parts of the crushing layer which surround the protrusion are manufactured in a second step. This method results in improved control of the conditions under which the protrusion is manufactured. The extent and connection surfaces of the protrusion to the surrounding material can also be formed with greater accuracy. It is also possible to make the protrusion of a material that requires hot isostatic pressing in conditions, as regards, for instance, temperature and pressure, that are unsuitable for the surrounding material.

According to another preferred method, the crushing layer has at least one protrusion protruding from the crushing layer and being made in a first step by sintering, casting or forging, the protrusion in a second step being arranged in the capsule and at least one powder material being introduced into the parts of the capsule which correspond to the parts of the crushing layer which surround the protrusion, the protrusion, after subjecting the materials to hot isostatic pressing and subsequent aftertreatment, having higher abrasive resistance than the parts of the crushing layer which surround the protrusion. As mentioned above, this makes it possible to select for the protrusion also such abrasive resistant materials as are not best suited for hot isostatic pressing.

According to a preferred method, the protrusion is formed as a step. The step ensures, as mentioned above, advantages in crushing. Preferably, the body is at least partly made of a substance selected from a group consisting of carbon steels and low alloy steels. Owing to these substances, the abutment surface of the body is easy to machine to narrow tolerances, as mentioned above.

### BRIEF DESCRIPTION OF THE DRAWINGS

The invention will now be described in more detail by way of embodiments and with reference to the accompanying drawings.

FIG. 1 shows a gyratory crusher.

FIG. 2 is a cross-sectional view of a portion of the crusher in FIG. 1 and shows an inner shell and an outer shell according to prior art.

FIG. 3 is a cross-sectional view and shows a wear part according to the invention in a first embodiment, formed as an inner shell.

FIG. 4 is a cross-sectional view and shows a wear part according to the invention in a second embodiment, formed as an inner shell.

FIG. 5 is a cross-sectional view and shows a wear part of the invention in a third embodiment, formed as an inner shell.

FIG. 6 is a cross-sectional view and shows a wear part according to the invention in a fourth embodiment, formed as an inner shell.

FIG. 7 is a cross-sectional view and shows wear parts according to the invention formed as an inner shell and an outer shell, intended for a crusher that is normally used in coarse crushing.

FIG. 8 is a cross-sectional view and shows a capsule for manufacturing wear parts according to the invention.

### DESCRIPTION OF THE PREFERRED EMBODIMENTS

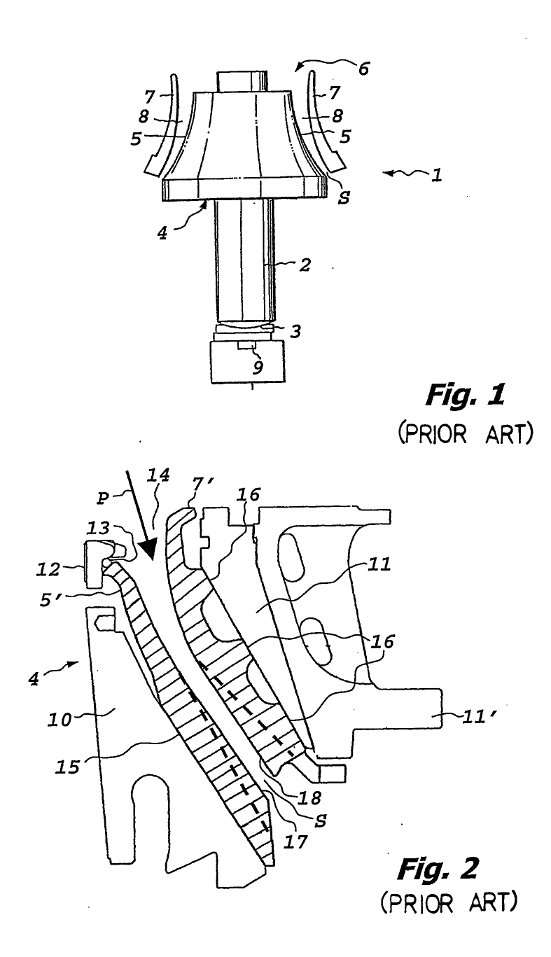

FIG. 1 shows a gyratory crusher 1. The crusher 1 has a crusher shaft 2 which at its lower end 3 is eccentrically mounted. In its upper portion, the crusher shaft 2 has a crushing head 4. The crushing head 4 has an inner shell 5, which in the simultaneous rotary and oscillating motions of the crusher shaft 2 crushes raw materials, that are supplied to the upper portion 6 of the crusher 1, against an outer shell 7. A crushing chamber 8 is formed between the inner shell 5 and the outer shell 7. As a rule, the function of the crusher 1 is determined by the gap S which is the smallest distance between the inner shell 5 and the outer shell 7 of the crusher 1. The crusher shaft 2 can by means of an adjusting device 9 be moved in the vertical direction. Thus, the gap S of the crushing chamber 8 can be adjusted, thus allowing setting in a desirable manner the relation between the amount of material that is crushed by the crusher 1 and the size of the crushed material.

FIG. 2 shows an inner shell 5′ and an outer shell 7′ of prior-art type. As illustrated, the inner shell 5′ is supported by a supporting part in the form of a support cone 10 included in the crushing head 4 and the outer shell 7′ on a supporting part 11 in the form of an intermediate ring. The inner shell 5′ is held on the support cone 10 by a nut 12, which by means of a ring 13, that is welded to the inner shell 5′ and the nut 12, holds the inner shell 5′ on the support cone 10. The outer shell 7′ is attached to a base 11′ by means of a bolt joint. When operating the crusher, raw materials are supplied to the inlet 14 of the crusher and conveyed in the direction of flow P of the raw material, (in FIG. 2 indicated by an arrow) downwards through the crusher 1. According to prior-art technique, both the inner shell 5′ and the outer shell 7′ are made of cast manganese steel. The abutment surface 15 of the inner shell 5′ on the support cone 10 is machined to narrow tolerances in complicated turning operations. In the same way, the abutment surfaces 16 of the outer shell 7′ on the supporting part 11 are machined to narrow tolerances. To ensure a correct gap 5, usually also the crushing surface 17 of the inner shell 5′ and the crushing surface 18 of the outer shell 7′ are machined by means of complicated turning operations.

The dashed lines in FIG. 2 indicate the extent of the inner shell 5′ and the outer shell 7′ after a period of wear. The wear makes it necessary to move the crusher shaft 2 upwards to maintain a constant gap S. When the crusher shaft 2 has reached its uppermost position, the inner shell 5′ must be replaced without its upper portion being worn out.

FIG. 3 shows a first embodiment of a wear part according to the invention in the form of an inner shell 5a for the gyratory crusher 1. The inner shell 5a has a body 19 made of a carbon steel which is easy to machine. The abutment surface 15 of the body 19 for abutment on the support cone 10 has been turned to narrow tolerances for a good fit to the support cone 10. The inner shell 5a has a crushing layer 20. The crushing layer 20 is made of two different powder materials 21 and 22, for instance Elmax and Vanadis 10 made by Uddeholm AB, SE, which have been subjected to hot isostatic pressing.

In hot isostatic pressing the body 19 and the crushing layer 20 will be partly joined by diffusion and form a bonding zone 20′ which extends along the entire contact surface between the body 19 and the crushing layer 20.

In the embodiment shown in FIG. 3, two powder materials 21, 22 are used in the crushing layer 20 as mentioned above. The first material 21 is placed at the end, located at the inlet 14, of the inner shell 5a in a first portion 21′ of the crushing layer 20, and the second material 22 is placed in a second portion 22′ of the crushing layer 20, which is positioned downstream of the first portion 21′ in the direction of flow P of the raw material. The materials 21, 22 are selected so that the second material 22 has higher abrasive resistance than the first material 21 after both materials being subjected to hot isostatic pressing. In a portion 23 of the crushing layer 20, the first material 21 gradually merges into the second material 22 in the direction of flow P of the raw material. In the embodiment in FIG. 3, uneven wear that arises in prior-art technique (FIG. 2) is thus avoided owing to the fact that the abrasive resistance of the crushing layer 20 along the direction of flow P of the raw material has been adjusted to the actual wear. As is evident from FIG. 3, the crushing layer 20 has on its outside a special curvature. This curvature, which is described, for instance, in GB2,123,314, is intended to maintain a constant inlet 14 as the crusher shaft 2 moves upwards subsequent to wear. Thus the inner shell 5a will have an almost constant profile during its entire life, which ensures that the correct gap S can be set without the capacity of the crusher 1 decreasing.

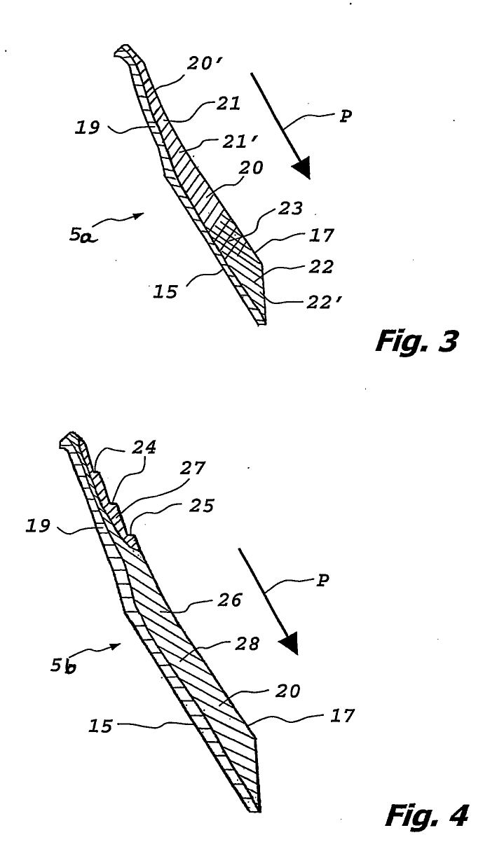

FIG. 4 shows a second embodiment of a wear part according to the invention in the form of an inner shell 5b. Like in the embodiment shown in FIG. 3, this inner shell 5b has a body 19 having an abutment surface 15 and being made in the manner as described above, and a crushing layer 20. The crushing layer 20 has, in its portion positioned at the inlet 14, a number of shoulders or steps 24, 25. The steps 24, 25, which can be analogized to rotationally symmetric stairs extending round the crushing layer 20 and which are positioned upstream of a portion 26, improve the possibility of crushing the raw material to smaller pieces and also improve the grain shape of the crushed raw material. The steps 24, 25, which in operation are exposed to heavy wear, are made of a powder material 27 having a higher abrasive resistance than the material 28 of which the remainder of the crushing layer 20 is made, after the materials being exposed to hot isostatic pressing. The steps 24, 25 will thus last longer than in the case if they had also been made of the material 28, thereby increasing the operating time in which the shell S exhibits the desired function.

The steps 24, 25 can be made at the same time as the remainder of the crushing layer 20 in the above isostatic pressing. However, it is also possible to make the steps 24, 25 in a first step, i.e. a first processing step, by hot isostatic pressing and then in a second step, i.e. a second processing step, make the remainder of the crushing layer. It is also possible to make the steps 24, 25 by casting, sintering, for instance of tungsten carbide, or forging, after which the parts of the crushing layer 20 which surround the steps 24, 25 are made of a powder material that is subjected to hot isostatic pressing.

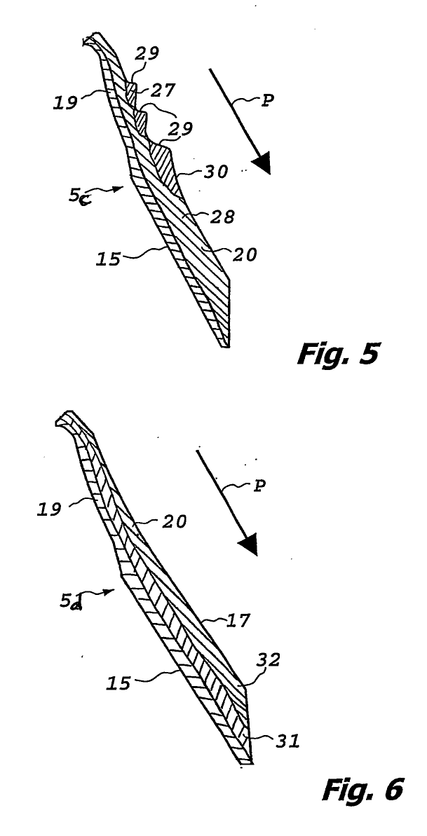

FIG. 5 illustrates a third embodiment of a wear part according to the invention in the form of an inner shell 5c. This embodiment differs from the embodiment shown in FIG. 4 essentially only by its inner shell 5 having larger shoulders or steps 29. The steps 29, which may be analogized to rotationally symmetric stairs extending round the crushing layer 20, give the advantage that a smaller crushing surface 30 is obtained, thus allowing the raw material to be crushed with greater force against this surface 30. The steps 29 thus prevent large objects from reaching the crushing surface 30. A certain degree of wear by the raw material also takes place in the area of the steps 29.

FIG. 6 illustrates a fourth embodiment of a wear part according to the invention in the form of an inner shell 5d. In this embodiment, the crushing layer 20 has at least two different layers 31, 32, viz, a lower layer 31 closest to the body 19 and an upper layer 32 which is harder than the lower layer 31. The hard, but brittle, layer 32 is supported by the softer lower layer 31. The outer surface of the harder layer 32 thus constitutes the crushing surface 17 of the crushing layer 20.

Both the softer layer 31 and the harder layer 32 are made by hot isostatic pressing of powder materials. The layers 31, 32 can be made simultaneously. Alternatively, the softer layer 31 can be made in a first step and the harder layer 32 can be made in a subsequent second step. It is also possible to make the lower layer 31 of a cast manganese steel, for instance a Hadfield steel. The manganese steel has relatively high abrasive resistance, which is advantageous if the upper layer 32 should be damaged at any point.

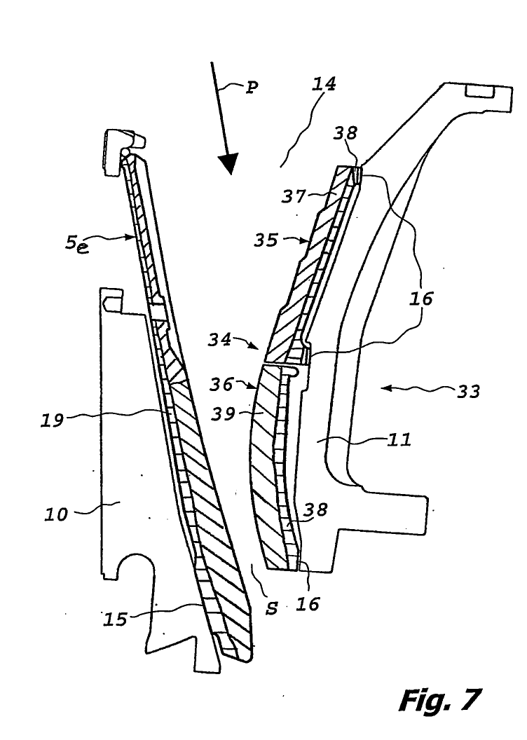

FIG. 7 illustrates a primary gyratory crusher 33. The primary gyratory crusher 33 is a type of gyratory crusher which is used for crushing large objects. Thus, the inlet 14 is very wide. The outer shell 34 of the primary gyratory crusher 33 is divided into a number of segments 35, 36 which are attached to a supporting part 11. The segment 35 has a crushing layer 37 which is made of a powder material that has been subjected to hot isostatic pressing and that is attached to a body 38. The body 38 is made of a carbon steel. The segment 36 positioned downstream of the segment 35 in the direction of flow P of the raw material has a crushing layer 39 which is made by hot isostatic pressing and is attached to a body 38. The crushing layer 39 has higher abrasive resistance than the crushing layer 37. Since the wear is smaller in the portions of the crusher 33 which are positioned close to the inlet 14, the segments 35, 36 will be worn at approximately the same rate in operation of the crusher, which ensures an even profile of the outer shell 34. The crusher 33 also has an inner shell 5e which is replaceably attached to a support cone 10. This shell 5e can be formed in the manner as described above with reference to FIGS. 3-6.

The hot isostatic pressing, which is described, for instance, in U.S. Pat. No. 3,695,597, is carried out by means of a capsule 40 (see FIG. 8). In the capsule 40, the body 19 is used as a wall. Otherwise, the capsule 40 has the geometric shape that is desired for the completed inner shell 5e. Steps 29, if any, that have been made in advance by, for instance, hot isostatic pressing, sintering, casting or forging, are placed in the capsule 40 in the positions as required in the completed crushing layer 20. In the capsule 40, at least one powder material is introduced in at least one opening 41. After vibrating, degassing and sealing, the capsule 40 is exposed to heat and pressure, whereby the powder material is deformed and joined by diffusion. The capsule 40 can then be removed. In some cases, the capsule 40 is joined with the crushing layer 20 and becomes part thereof. After subsequent treatment, comprising, for instance, tempering, the inner shell 5e is ready for use. Owing to the conditions in pressing, the crushing surface 17 of the shell 5e need not be machined at all but satisfies the tolerances that are required for the selected gap S. The abutment surface 15 of the body 19 can be machined either before pressing or after the same.

It will appreciated that a number of modifications of the embodiments described above are feasible within the scope of the invention.

Thus, for instance an inner shell 5 or an outer shell 7 can be formed, in which the steps 24, 25, 29 shown in FIGS. 4 and 5 are combined with a crushing layer 20 containing the combinations of powder materials 21, 22, 31, 32 shown in FIG. 3 and/or FIG. 6, said materials being subjected to hot isostatic pressing with a view to forming different portions and layers. Of course, a plurality of, for instance 2-7, different powder materials can be used for the different layers, portions and steps of the wear part. The materials can either merge more or less gradually into each other or be separated by distinct limits. Such limits may consist of, for instance, thin metal foils that are inserted into the capsule 40.

Wear parts according to the invention can be manufactured, inter alia, for the above-described gyratory crushers and jaw crushers. Jaw crushers in general are described, for instance, in WO 00/25926 and U.S. Pat. No. 4,927,089. A jaw crusher has two jaws each having the shape of a relatively flat surface, one jaw crushing the raw material against the other jaw by a reciprocating motion. A raw material is introduced into the upper portion of the jaw crusher and passed downwards through the crusher in an essentially vertically downward direction of flow of the raw material. When passing downwards through the jaw crusher, the raw material will be crushed a plurality of times to increasingly smaller dimensions. The jaws comprise supporting parts to which wear parts according to the invention can be attached by welding or bolting. A great deal of the wear will arise in the lower parts of the jaw crusher where a very large number of objects of the raw material are to be crushed. In many cases it will thus be convenient to use wear parts in the jaw crusher that have been manufactured, for instance, according to the principles as described in connection with FIGS. 3 and 7. Gyratory crushers and jaw crushers are impact-type multi-action crushers, i.e. crushers in which a piece of the raw material is crushed several times while passing through the crusher and by impact between two surfaces that are accelerated towards each other and strike against the raw material.

The body 19 is made of a substance which is easy to machine but which at the same time has the mechanical strength that is necessary to support the crushing layer 20. The body can be cast, forged or cold- and/or hot-worked to the correct shape. Since the body is not in contact with the raw material, it can be made of a substance of low abrasive resistance. Low abrasive resistance often makes the substance easy to machine. The substances that are most convenient for the body are carbon steels and low alloy steels. The abutment surface 15, 16 of the body on the supporting part 10, 11 can be machined to narrow tolerances, for instance by turning, milling or grinding.

Substances that are easy to weld are particularly advantageous as substance for the body. The wear part can be attached to the supporting part by means of a weld that should resist high loads. Particularly suitable substances are therefore carbon steels and lower alloy steels.

The segments 35, 36 illustrated in FIG. 7 can also each be formed according to the principles described above in connection with FIGS. 3-6. Thus, wear parts for gyratory crushers as well as jaw crushers can be made in several segments. Each segment may either comprise a single powder material or a plurality of materials. The segments may also comprise steps.

When a plurality of steps 24, 25, 29 are used, they can be made of the same material, but also of different materials and by different methods. For instance, it is possible to make the steps 24 of a powder material that is subjected to hot isostatic pressing, and the step 25 of a still harder material which has been made in advance by sintering.

It is also possible to manufacture a body and a crushing layer each separately, for instance by casting, machining, forging or hot isostatic pressing, and then attach the body and the crushing layer to each other by hot isostatic pressing, also referred to as diffusion bonding.

1-23. (canceled)

24. A wear part configured for detachable mounting on a supporting part in an impact-type multi-action crusher, the wear part being at least partly manufactured by hot isostatic pressing, and including a body for mounting of the wear part on a supporting part, and a crushing layer attached to the body and adapted to be brought into repeated contact with a raw material which is to be crushed; the body comprising a substance easily machinable to narrow tolerances than the crushing layer; and the crushing layer comprising a material of higher abrasive resistance than the body.

25. A wear part as claimed in claim 24, wherein the crushing layer comprises at least one powder material subjected to hot isostatic pressing; and the substance of which the body is comprised has good weldability properties.

26. A wear part as claimed in claim 24 wherein the crushing layer comprises at least two powder materials subjected to hot isostatic pressing without first being completely mixed with each other, said powder materials, following the pressing and subsequent after-treatment, having different respective abrasive resistances.

27. A wear part as claimed in claim 26, wherein the powder material having a highest abrasive resistance is arranged at a highest-wear region of the crushing layer.

28. A wear part as claimed in claim 24 wherein the crushing layer and the body are joined together at a bonding zone.

29. A wear part as claimed in claim 24 wherein the body at least partly comprises one of carbon steels or low alloy steels.

30. A wear part as claimed in claim 24, wherein a first portion of the crushing layer comprises at least one first powder material; a second portion of the crushing layer located downstream of said first portion in a direction of flow of raw material to be crushed comprising at least one second powder material; the second powder material, following hot isostatic pressing and subsequent after-treatment of the first and second powder materials, having higher abrasive resistance than the first material.

31. A wear part as claimed in claim 30, wherein the first material gradually merges into the second material in such a manner such that abrasive resistance of the crushing layer increases gradually in a direction of raw material flow, the abrasive resistance properties arranged in corresponding relationship to the wear load in operation, wherein the crushing layer is kept essentially intact during wearing of the wear part.

32. A wear part as claimed in claim 24, wherein the crushing layer comprises first and second powder materials, and at least one protrusion formed of the second powder material; the second powder material, following hot isostatic pressing and subsequent after-treatment of the first and second powder materials, having higher abrasive resistance than the first powder material.

33. A wear part as claimed in claim 26, wherein the crushing layer has at least one protrusion formed by one of casting, sintering or forging, the protrusion having higher abrasive resistance than a material of the crushing layer disposed adjacent the protrusion.

34. A wear part as claimed in claim 33, wherein the protrusion is configured as a rotationally symmetric step structure.

35. A wear part as claimed in claim 24 comprising a shell configured for use in a gyratory crusher.

36. A wear part as claimed in claim 24, wherein the crushing layer comprises at least two powder materials, which, after the materials being subjected to hot isostatic pressing, have different respective hardnesses; a softest of the powder materials being located in a first layer closest to the body, and a hardest of the powder materials being located in a second layer disposed outside of the first layer.

37. A method of manufacturing a wear part configured for detachable mounting on a supporting part of an impact-type multi-action crusher, comprising the steps of:
A) introducing at least one abrasive-resistant powder material into a capsule,
B) degassing and sealing the capsule,
C) subjecting the degassed and sealed capsule to hot isostatic pressing to form a crushing layer, and
D) causing the crushing layer to be attached to a body formed of a substance which is less abrasive resistant and more easily machinable to narrow tolerances than the crushing layer.

38. The method according to claim 37, wherein step A comprises introducing, without being mixed together, first and second powder materials, the second material having higher abrasive resistance than the first material following step C; wherein step A further comprises arranging the second powder material at a position of greatest wearing of the crushing surface.

39. The method according to claim 37, wherein step D comprises positioning the body to form a wall of the capsule during step A.

40. The method according to claim 37, wherein step A comprises introducing first and second powder materials into first and second parts, respectively, of the capsule, wherein the second material is located downstream of the first material in a rock flow direction, the second material exhibiting a higher abrasive resistance than the first material following step C.

41. The method according to claim 40, wherein the first material merges into the second material during step C, and the crushing layer exhibits an abrasive resistance that progressively increases from the first material to the second material.

42. The method according to claim 37 wherein step A includes arranging a first powder material with a protrusion in the capsule, and arranging a second powder material in the capsule adjacent the first material; wherein following step C, the first material has a higher abrasive resistance than the second material.

43. The method according to claim 37, wherein step A includes arranging a first powder material with a protrusion in the capsule, and subsequent to step C, affixing to the first material a second material of less abrasive resistance than the first material.

44. A method of manufacturing a wear part configured for detachable mounting on a supporting surface of an impact-type multi-action crusher, comprising the steps of:
A) forming a first crushing layer portion in the form of a protrusion by one of sintering, casting, or forging,
B) inserting the protrusion into a capsule,
C) introducing into the capsule at least one powder material adjacent to the protrusion,
D) degassing and sealing the capsule,
E) subjecting the degassed and sealed capsule to hot isostatic pressing, whereafter the projection exhibits higher abrasive resistance than the adjacent material.

45. The method according to claim 44, wherein the protrusion comprises at least one step-shaped structure.

46. The method according to claim 37, wherein the body comprises one of carbon steel or low alloy steel.
